(19) United States
(12) Patent Application Publication
(10) Pub. No.: US 2010/0171603 A1
(43) Pub. Date: Jul. 8, 2010

(54) KEYLESS SECURITY LOCK FOR LIGHT ELECTRIC VEHICLES

(76) Inventors: RAKESH KUMAR DHAWAN, DULLES, VA (US); Mohammed Ziaur Rahman, Herndon, VA (US); Yamsi Krishna Annavjjula, Broadlands, VA (US); Ernie Shik Kim, Centreville, VA (US)

Correspondence Address: Electric Motion Systems, LLC, 45150 Business Court , Ste. 300, Dulles, VA, 20166, US

(21) Appl. No.: 12/348,022

(22) Filed: Jan. 2, 2009

(51) Int. Cl. B60R 25/10

(52) U.S. Cl. 340/426.13

(57) ABSTRACT

A removable keyless security lock for a light electric vehicle which employs existing permanent magnet brushless motor or motors that is or are programmed to produce high resistance to paddling to prevent theft. This antitheft mode offer resistance to motor rotation, thereby effectively locking the movement of the electric bicycle. An external energy source, such as, a battery is not required to keep the antitheft mode activated. The security lock is easily removable without using any tools and this will not deactivate the antitheft mode.

### FIELD OF THE INVENTION

The present invention relates to light electric vehicle security systems and more particularly pertains to a keyless security lock for an electric bicycle which employs existing permanent magnet brushless motors and other devices to present an antitheft mode.

### BACKGROUND OF THE INVENTION

It has been found that health conditions and environmental awareness have prompted many people in both the United States and Europe to turn to alternative forms of transportation, such as bicycles, especially electric bicycles, for both business and pleasure. Bicycling is a very popular sport, and as, is known to the participants, the bicycle is becoming more technologically developed wherein the use thereof for traveling longer distances is growing. Further, the use of the bicycle for a utility form of transportation (work and play) is rapidly becoming more commonplace with the concurrent desirability of means for carrying miscellaneous luggage and various accessory items becoming an increasing need. It has also been found that an increasing sophistication in bicycle designs has caused a significant increase in the cost of bicycles over the past several years. The increased popularity of bicycles and motorcycles has created a security problem for the owners of such vehicles.

Another problem not quite so obvious is the problem raised by the increased frequency with which riders of bicycles and motorcycles carry personal property of value on their vehicles, and require security facilities for such articles when the cycle is parked. Typical items ordinarily carried might include a lunch, coat, briefcase, or recreational equipment.

The combination of increasing popularity and increasing price has thus made the bicycle, especially the electric bicycle, a high profile target for thieves. Accordingly, it has been found that there are a growing number of commuter cyclists, in both metropolitan and suburban areas, who lock up their bicycles in public areas, such as outside their place of employment or outside of the city's rapid transit stations.

Various types of security devices in combination with cables, chains, and so forth have been known to be used for the purpose of securing ordinary and electric bicycles and wheels when unattended. Whereas many of these locks have been found to achieve the required security, such a security system necessitates the carrying and storing of this apparatus at all times, as well as the attaching of it to the bicycle for security during non-use periods. This is a very inconvenient, bulky, and inefficient approach, causing unnecessary expense and effort.

Heretofore, there have been known several locking bicycles which have been operated by alarms means. The present invention deals with a keyless security lock system for an electric bicycle that is already built into the system of the bicycle. The present invention thus claims an entirely automatic keyless system of security for electric bicycles.

The relevant prior art methods, which will deal with locking system of bicycles in general, are as follows:

U.S. Pat. No. 4,621,873 describes as an integral lock and protected opposite end formed in combination with a quick release apparatus for securing a wheel to a bicycle frame in a theft proof manner. The hand-operated lever of the quick release is prevented from rotating by a locking pin which engages a bore in the quick release assembly to prevent rotation thereof, while the adjustable nuts on the opposite threaded end are prevented from being removed by the end cap housing which encases and protects the nuts in a manner such that neither the end cap housing or the nuts can be removed when the assembly is mounted on a bicycle. When secured, the quick release lever cannot be rotated, nor can the nuts securing the opposite end be accessed, offering complete security to the object secured.

U.S. Pat. No. RE29,521 claims as anti-theft locking system for bicycles or other portable items that utilizes a high strength hollow flexible tether which may be looped around the stationary object and plugged into a locking receiver or socket on the bicycle or, alternately, may be plugged directly into a locking opening provided in a hollow post such as a parking meter post. The tether has retractable spring-urged latches operated by an internal wire controlled by a key-locking mechanism fixed on the cycle or other portable article Idea locking means for a bicycle or the like consists of a locking unit permanently attached to a frame member of the bicycle. A flexible tether has an end permanently attached to the locking unit and has a plug-in lock element on its free end adapted to enter a receiver on the locking unit after being looped around an anchoring object

U.S. Pat. No. 3,827,773 discloses locker construction incorporating locking means for cycles which incorporates a locking mechanism, including a chain or cable, for locking a bicycle or motorcycle to the locker for security purposes. The lock construction for the locker incorporates means for locking one end of the chain or cable to the locker.

U.S. Pat. No. 5,278,538 describes a bicycle security system that includes a locking bicycle rack and employs a user's automated teller banking card to operate the system and debit charges accrued in connection with use of the system from the user's bank account. The locking system has an electronic control means which locks and unlocks the bicycle rack by means of a banking card. The electronic control means includes a timer which tracks time in connection with use of the system. The control means thereafter calculates a charge based upon the use of the system and debits the accrued charges from the user's bank account via telephone modem. The locking bicycle rack incorporates three locking pins which lock the bicycle at the frame, the front wheel and the rear wheel to provide a high degree of security.

However the inventions envisaged by the prior art deal with external bicycle security devices, that may be subject to vandalism and misuse. Further inbuilt bicycle security devices relate to key lock mechanisms or the like which can be diffused by the removal of a bicycle wheel or the like. This difficulty can be easily overcomes by thieves, especially if the vehicle is parked for a long period of time in one place.

The present invention relates to keyless security lock for an electric bicycle was developed to alleviate this problem. The present invention uses permanent magnet motors as a propulsion unit. The motor can be programmed to produce high resistance to paddling to prevent theft. In this mode (antitheft mode) the motor resists rotation, thereby, making very hard for unauthorized person to paddle the bike.

A major advantage of the present invention over the prior art is that in the application of the anti theft mode, the bicycle will be very hard to paddle, since the existing parts of the electric bicycle perform the function of offering anti theft security to the user. The other distinguishable feature of the present invention is that the last operating mode of the motor is always saved in EEPROM. Thus the antitheft mode prevents the electric bicycle from being stolen even if the motor is disconnected from the power supply of the bicycle. Another distinguishable feature of the present invention is that the security lock is easily removable from the bicycle system without using any tools and this will not deactivate the antitheft system.

Further it will be apparent to those skilled in the art that the objects of this invention have been achieved by providing a keyless security lock for an electric bicycle which is unique in nature unlike existing locking systems that are suited only for limited purposes. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This present invention may be summarized, at least in part, with reference to its objects.

The foremost object of the present invention is to present a keyless security lock mechanism for electric bicycles.

Another object of the present invention is to present a keyless security lock mechanism which is easier to manufacture, being part of the bicycle.

Another object of the present invention is to is to present a keyless security lock mechanism that is reliable to operate, and provides improved security to prevent tampering or unauthorized access.

Yet another object of the present invention is to present a bicycle security system which is easy to use.

Additional objects, advantages and novel features of the invention will be set forth in part in the description which follows, and in part will become apparent to those skilled in the art upon examination of the following, or may be learned by practice of the invention.

These and other objects and advantages and features of the present invention will be more readily apparent when considered in reference to the following description and when taken in conjunction with the accompanying drawings listed below

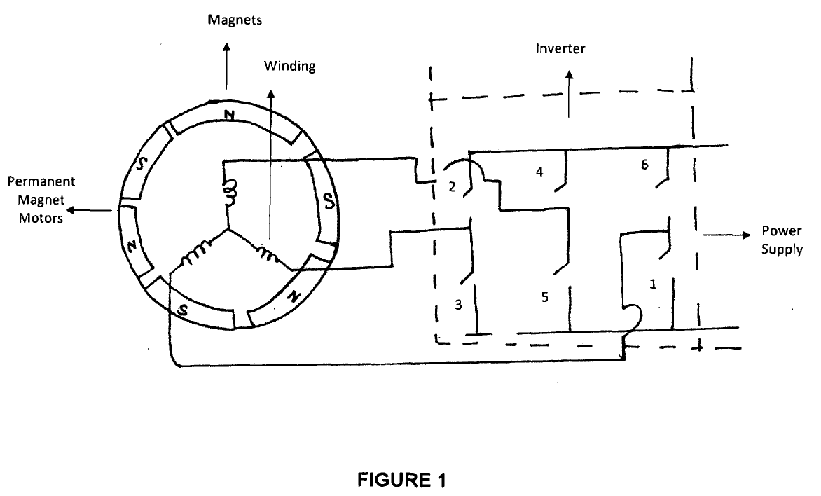

FIG. 1 is a diagram illustrating the working principle of the invention.

### DETAILED DESCRIPTION OF THE INVENTION

The following description is presented to enable any person skilled in the art to make and use the invention, and is provided in the context of particular applications of the invention and their requirements. The present invention can be configured as follows:

The present keyless security lock is designed for use in light electric vehicles such as a 1, 2, 3 or 4 wheeler and powered by an electric motor with an output power of less than 15 kW.

As illustrated in FIG. 1, the invention employs the working of the following components and external power supply:

1. Permanent Magnet Brushless Motors

2. Motor Windings

3. Switches 1 to 6

4. DC to AC Inverter

5. Processor, such as, micro-Controller, DSP etc.

The permanent magnet brushless motors are operated through DC to AC inverters. Inverters are like multiple switching devices connected between DC energy source and motor winding. Each motor winding has two switches. One switch connects the winding to the positive terminal of the power supply. The other switch connects the winding to the negative terminal of the power supply. The switches are controlled by an intelligent processing unit known as micro-controller. In normal mode of operation the controller operates the switches depending on permanent magnet position of the motor and energizes the proper motor windings to create attractive or repulsive force between permanent magnets and windings.

In antitheft mode all the switches connected to the negative terminal of the power supply, i.e. Switches 1, 3 and 5 in FIG. 1, are kept closed. All motor windings are now shorted. Currents through the shorted windings create resistance to motor rotation which makes the bicycle hard to paddle.

The last operating mode of the motor is always saved in EEPROM. Every time the motor is powered on it goes to its last operating mode. If the last mode saved in EEPROM is the ‘antitheft’ mode then the bicycle will be very hard to paddle during power up.

If the motor is disconnected from the power supply then the electric bicycle can be paddled like a normal bicycle. However, over some speed level, the permanent magnet motor, now acting like a generator, generates enough power by itself to power up the microcontroller. When the electromagnetic means is again energized, and if the last mode saved in EEPROM is the ‘antitheft’ mode then the microcontroller will turn on the switches connected to the negative terminal of the power supply. The bicycle will be very hard to paddle. So the antitheft mode prevents bicycle from being stolen even if the motor is disconnected from the power supply of the bicycle.

It is seen therefore that the present invention provides an effective keyless security system for electric bicycles, combining the key features of security and ease of operation. The inbuilt electromagnetic locking mechanism employed in the present invention deters vandalism. The saving of the last operating mode of the motor as ‘antitheft mode’ in EEPROM, ensures that the antitheft mode is reapplied on starting the bicycle or even if the motor is disconnected from the power supply of the bicycle.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A Keyless Security Lock for light Electric vehicles comprising of single or multiple Permanent Magnet Brushless Motors, single or multiple Inverters and single or multiple processors such as Micro-Controllers and DSPs, wherein said keyless security lock is easily removable without using any tools and the vehicle remains locked and the security mode is not dependent on any external energy source such as batteries.

2. A keyless security lock as claimed 1, wherein said permanent magnet brushless motors are operated through said DC to AC inverters.

3. A keyless security lock as claimed in claim 1, wherein said motor winding has two switches of which one switch connects said winding to the positive terminal of the power supply and the other switch connects said winding to the negative terminal of the power supply.

4. A keyless security lock as claimed in claim 1, wherein said switches are controlled by said micro-controller.

5. A keyless security lock as claimed in claim 1, wherein said switches are operated depending on position of permanent magnets in said permanent magnet brushless motor and said motor windings to which said switches are connected are energized to create attractive or repulsive force between said permanent magnets and said windings, in the normal mode of operation.

6. A keyless security lock as claimed in claim 1, wherein the last operating mode of said motor is saved in EEPROM.

7. A keyless security lock as claimed in claim 1, wherein all said switches connected to the negative terminal of power supply are kept closed and said motor windings are shorted to produce currents that create resistance to said motor rotation, in the antitheft mode of operation.

8. A keyless security lock as claimed in claim 1, wherein said motor can function as a generator and generates power to power up said microcontroller, in the disconnected mode of operation.

9. A keyless security lock as claimed in claim 1 and 7, wherein said microcontroller turns on said switches connected to the negative terminal of the power supply, in the disconnected mode of operation, if the last mode saved in EEPROM is the antitheft mode of operation.

10. A keyless security lock as claimed in claim 1, wherein the said light electric vehicle is a 1, 2, 3 or 4 wheeler and powered by an electric motor with an output power of less than 15 kW.
